(19) United States
(12) Patent Application Publication
(10) Pub. No.: US 2010/0241760 A1
(43) Pub. Date: Sep. 23, 2010

(54) Web Front-End Throttling

(75) Inventors: Jian Zhang, Redmond, WA (US); Lida Li, Redmond, WA (US); Christopher` Anthony Clark, JR., Bellevue, WA (US); Ivonne Dnisse Galvan Coiffier, Bellevue, WA (US); Rahul Sakdeo, Bellevue, WA (US); Don Adam Hedgpeth, Seattle, WA (US); Seth A. Sanusi, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/406,699

(22) Filed: Mar. 18, 2009

(51) Int. Cl. G06F 15/173

(52) U.S. Cl. 709/235

(57) ABSTRACT

A server computer includes a performance monitor module and a throttling logic module. The performance monitor module includes performance monitors that monitor system parameters of the server computer. The throttling logic module determines whether a system parameter monitored by a performance monitor exceeds a predetermined threshold. When a system parameter exceeds a predetermined threshold, the throttling logic module sets a throttling flag. The throttling logic module activates throttling at the server computer when at least one throttling flag is set for each of a predetermined number of time snapshots. The activation of throttling limits the processing of request messages received by the server computer.

### BACKGROUND

Web front-end servers provide an interface to client systems that attempt to access information from database servers on the Internet. A web front-end server typically processes a client request, forwards the request to a database server and returns the obtained data to the client system.

Online browser-based document and collaboration systems typically provide multiple web front-end servers to handle client requests. Clients expect their requests for access to a database server to be processed in a timely manner. However, when systems get busy, web front-end servers can sometimes get overloaded and not respond to a client request in a timely manner.

### SUMMARY

Embodiments of the invention are directed to providing a throttling capability for a server computer. The server computer includes a performance monitor module, a throttling logic module and a throttling configuration module. The performance monitor module comprises one or more performance monitors. Each performance monitor monitors a system parameter of the server computer. The throttling logic module determines whether a system parameter monitored by a performance monitor exceeds a predetermined threshold. When a system parameter exceeds a predetermined threshold, the throttling logic module sets a throttling flag.

The throttling configuration module stores the predetermined threshold for each system parameter monitored by the one or more performance monitors. The throttling configuration module also stores one or more throttling logic parameters. The throttling logic module activates throttling at the server computer when at least one throttling flag is set for each of a predetermined number of time snapshots. The activation of throttling limits the processing of request messages received by the server computer.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for web front-end throttling.

FIG. 2 shows example modules of a web front-end server.

FIG. 3 shows an example logic diagram for an example throttling mechanism used in web front-end throttling.

FIG. 4 shows a flow chart of an example operation performed at an example web-front end server.

FIG. 5 shows a flow chart of one of the example operations shown in FIG. 4.

FIG. 6 shows a flow chart of one of the example operations shown in FIG. 5.

FIG. 7 shows a flow chart for another of the example operations shown in FIG. 5.

FIG. 8 shows an operating environment for a system that implements web front-end throttling.

### DETAILED DESCRIPTION

The present disclosure is directed to systems and methods for providing a throttling capability for a web front-end server. The systems and methods use performance monitors to monitor the system health of a web front-end server. When one or more performance monitors indicate that system resources fall outside of predetermined thresholds over a specified time period, a throttling is activated on the web front-end server. When the throttling is activated on the web front-end server, certain types of client request messages, typically request messages having low priority, are not processed by the web front-end server. Instead, an error message, typically indicating a system busy state, is returned to the requesting client system.

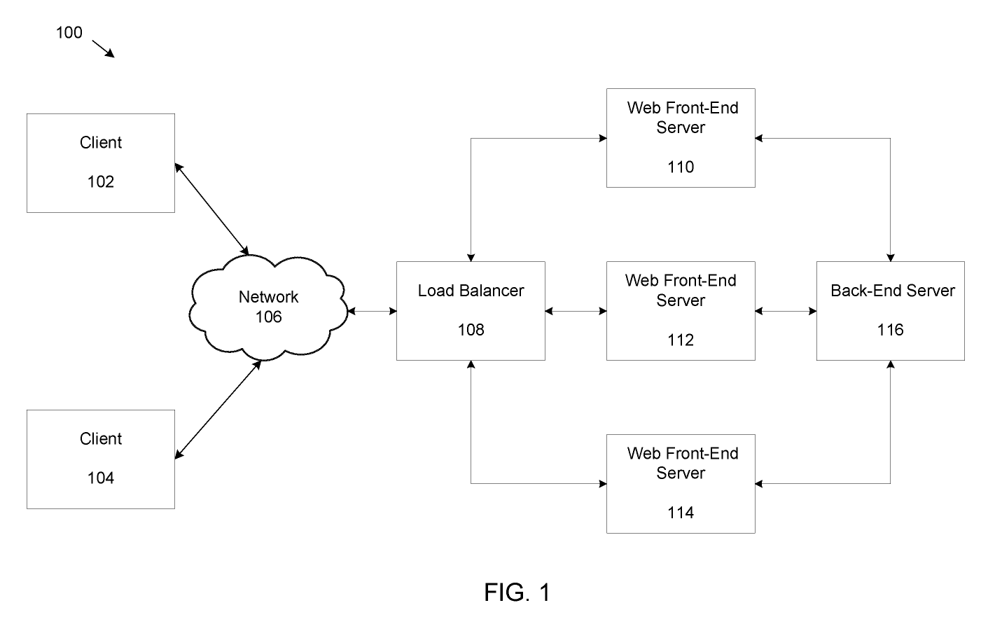

FIG. 1 shows an example system 100 for web front-end (WFE) throttling. The example system 100 includes clients 102 and 104, network 106, load balancer 108, WFE servers 110, 112, 114 and back-end server 116. Greater or fewer clients, WFEs, back-end servers, load balancers and networks can be used. In the present disclosure, the terms WFE and WFE server are used interchangeably.

In example embodiments, clients 102 and 104 are computing devices, such as desktop computers, laptop computers, terminal computers, personal data assistants, or cellular telephone devices. Clients 102 and 104 can include input/output devices, a central processing unit (“CPU”), a data storage device, and a network device. In the present application, the terms client and client computer are used interchangeably.

WFEs 110, 112 and 114 are accessible to clients 102 and 104 via load balancer 108 through network 106. Back-end server 116 is accessible to WFEs 110, 112 and 114. Load balancer 108 is a server computer. Load balancer 108, WFEs 110, 112 and 114 and back-end server 116 can include input/output devices, a central processing unit (“CPU”), a data storage device, and a network device. In example embodiments, network 106 is the Internet and clients 102 and 104 can access WFEs 110, 112 and 114 and resources connected to WFEs 110, 112 and 114 remotely. In the present application, the terms server and server computer are used interchangeably.

In an example embodiment, the example system 100 is an online, browser-based document collaboration system. An example of an online, browser-based document collaboration system is Microsoft Sharepoint from Microsoft Corporation of Redmond, Wash. In example system 100, back-end server 116 is a SQL server, for example SQL Server 2008 from Microsoft Corporation of Redmond, Wash.

In the example system 100, WFEs 110, 112 and 114 provide an interface between clients 102 and 104 and back-end server 116. The load balancer 108 is a server computer that directs requests from clients 102 and 104 to WFEs 110, 112 and 114. The load balancer 108 uses factors such as WFE utilization, the number of connections to a WFE and overall WFE performance to determine which WFE server receives a client request.

In example system 100, an example of a client request may be to access a document stored on back-end server 116, to edit a document stored on back-end server 116 or to store a document on back-end server 116. When load balancer 108 receives a client request over network 106, load balancer 108 determines which one of WFE server 110, 112 and 114 receives the client request. In spite of attempting to balance requests among WFE server 110, 112, and 114, the system resources of one or more of WFE server 110, 112 and 114 may be depleted to the extent that a WFE may not be able to accept the client request.

Each WFE in example system 100 includes a throttling mechanism. The throttling mechanism determines when the WFE activates throttling. When throttling is activated on a WFE, client request messages of a low priority are rejected at the WFE and an error reply message indicating a WFE busy state is sent from the WFE to the client 102, 104 making the request.

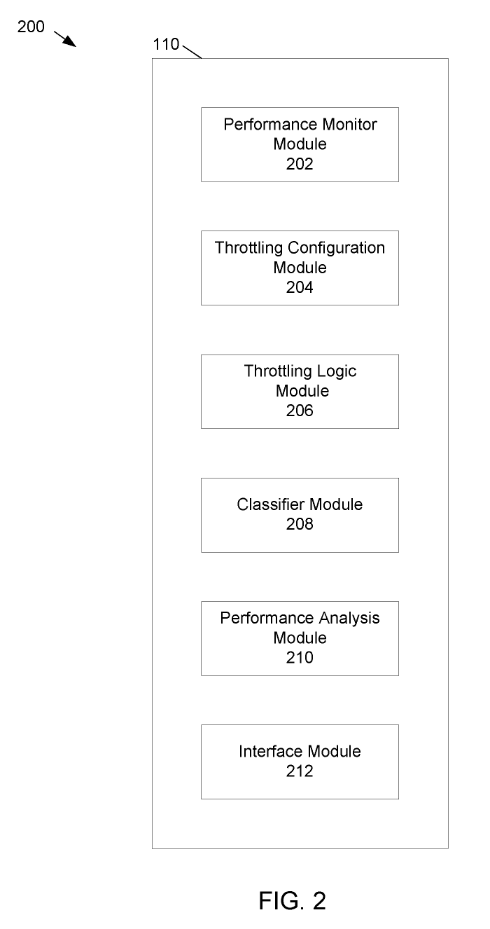

FIG. 2 shows example WFE 110 in more detail. As shown in FIG. 2, example WFE 110 includes example performance monitor module 202, example throttling configuration module 204, example throttling logic module 206, example classifier module 208, example performance analysis module 210 and example interface module 212.

Example performance monitor module 202 includes one or more performance monitors that keep track of system parameters on WFE 110 that are indicative of server health. Typically, WFE 110 includes one performance monitor for each monitored system parameter. A performance monitor is typically a counter that stores a count of the value of the system parameter that is monitoring. In the present disclosure, the terms performance monitor and performance counter are used interchangeably.

Examples of system parameters that the performance counters monitor include resource usage parameters such as percentage of CPU use and available WFE memory in megabytes and performance parameters such as the number of requests queued by the WFE and request wait time in the queue in milliseconds. In example system 100, example requests queued may be ASP.NET requests and request wait time may be ASP.NET request wait time. ASP.NET is a web application framework developed and marketed by Microsoft that allows programmers build dynamic web sites, web applications and web services. ASP.NET is frequently used to build Microsoft Sharepoint applications.

The example throttling configuration module 204 stores a threshold for each performance counter. Each threshold is a configurable, predetermined threshold. Each threshold may be configured manually by a system administrator or programmatically based on a performance analysis of a WFE. Each threshold represents a limit on a system parameter monitored by a performance counter. Depending on the system parameter monitored, the threshold represents an upper limit or a lower limit on the system parameter. A performance count that exceeds the upper limit or that drops below the lower limit indicates a performance related issue.

The example throttling configuration module 204 also stores one or more throttling logic parameters. The throttling logic parameters specify aspects of the throttling mechanism. Example throttling logic parameters include the number of time snapshots needed to determine whether to activate throttling and the time interval between time snapshots. Other throttling logic parameters are possible. Each throttling logic parameter is configurable.

The example throttling logic module 206 monitors the one or more performance counters and determines when to activate throttling for a WFE. Typically, the determination of when to activate throttling for example WFE 110 is an n-step process. In the example n-step process the one or more performance counters are monitored at n points in time. The first point in time is designated as time snapshot 1 and the nth point in time is designated as time snapshot n.

In the example n-step process, the example throttling logic module 206 determines whether a system parameter monitored by a performance counter exceeds a predetermined threshold. In example embodiments, when a system parameter exceeds a predetermined threshold, the value of the system parameter either exceeds an upper limit or drops below a lower limit, depending on the system parameter monitored. For example, when CPU usage exceeds a predetermined threshold, the value of CPU usage exceeds an upper limit. However, when available memory exceeds a predetermined threshold, the value of available memory drops below a lower limit.

The first step in the example n-step process is to monitor the one or more performance counters at time snapshot 1. When the one or more performance counters are monitored at time snapshot 1, if a system parameter monitored by a performance counter exceeds an upper limit threshold or drops below a lower limit threshold, the performance monitor associated with the performance counter sets a throttling flag for the performance monitor.

The next step in the n-step process is to monitor the one or more performance counters at time snapshot 2. Time snapshot 2 is a predetermined time interval from time snapshot 1. An example time interval that is typically used is 5 seconds. The time interval is a configurable value and other time intervals may be used.

When the one or more performance counters are monitored at time snapshot 2, if a system parameter monitored by a performance counter exceeds an upper limit threshold or drops below a lower limit threshold, if a throttling flag has not already been set for the performance monitor associated with the performance counter, the performance monitor associated with the performance counter sets a throttling flag for the performance monitor.

This same process is performed for each of the remaining steps in the n-step process. For example, if n is equal to 5, the one or more performance counters are additionally monitored at each of time snapshots 3, 4 and 5. When the one or more performance counters are monitored at each of time snapshots 3, 4 and 5, if a system parameter monitored by a performance counter exceeds an upper limit threshold or drops below a lower limit threshold, if a throttling flag has not already been set for the performance monitor associated with the performance counter, the performance monitor associated with the performance counter sets a throttling flag for the performance monitor.

At time snapshot n, the example throttling logic module 206 determines whether at least one throttling flag was set at time snapshot 1 and whether at least one throttling flag is set at each of time snapshots 2-n (meaning time snapshot 2 to time snapshot n). In example embodiments where n is equal to 2, only two time snapshots are used. If the example throttling logic module 206 determines that at least one throttling flag was set at time snapshot 1 and at least one throttling flag was set at each of time snapshots 2-n, the example throttling logic module 206 activates throttling for example WFE 110. When the throttling state is activated at WFE 110, all request messages received at WFE 110 having a low priority are not processed by WFE 110. Instead, WFE 110 sends an error message, typically a busy error, to the client that initiated the request.

The one or more performance monitors continually monitor the system parameters associated with the corresponding performance counters. When a throttling flag is set for a performance counter, the throttling flag remains set if the system parameter monitored by the performance counter continues to exceed an upper limit or remain below an upper limit. However, when the system parameter monitored by the performance counter returns to an acceptable value, being at or dropping below the upper limit or being at or exceeding the lower limit, the throttling flag for the performance counter is reset.

When making a determination whether to activate throttling for the example WFE 110, the example throttling logic module 206 does not consider which performance counter set a throttling flag. The determining factor is that at least one throttling flag is set at time snapshot 1 and at least one throttling flag is set at each of time snapshots 2-n. In example embodiments, a throttling state may be activated if different performance counters set a throttling flag at time snapshot 1 and at each of time snapshots 2-n or if a throttling flag is set for the same performance counter at time snapshot 1 and at each of time snapshots 2-n.

The number n of time snapshots is configurable. In some example embodiments, the example throttling logic module 206 uses two time snapshots to make a determination as to whether to activate a throttling state at the example WFE 110. The example throttling logic module 206 uses two time snapshots in order to minimize the possibility of spikes in performance setting a false alarm throttling state. For example, there may be a burst of CPU activity that causes a performance counter monitoring CPU activity to exceed a threshold. This burst of CPU activity may be a spike, lasting only a short period of time. Because it is not desirable to activate a throttling state for a WFE for a short spike in activity, two time snapshots are used in this example embodiment. In other example embodiments more than two time snapshots may be used.

The example classifier module 208 assigns priorities to message types and determines which messages may be processed when throttling is activated and which messages may be rejected when throttling is activated. In general, is it desirable to permit write operations to be completed and not be throttled, whereas read operations, for example a request for a web page, are more likely to be throttled. For example, if a user on client 102 opens a document for editing, it is desirable to allow the user to complete the editing of the document and not be delayed in editing the document because a WFE is busy. Similarly, if a user on client 104 tries to access a web page for viewing and receives a busy error, the user may simply try again at a later time.

In example embodiments, classifier module 208 classifies some messages by HTTP message type. For example, HTTP Post and HTTP Put message types typically are assigned a high priority and a HTTP Get message type is typically assigned a low priority. In an example embodiment, if throttling is activated on example WFE 110 and WFE 110 receives an HTTP Post or HTTP Put message request, WFE 110 processes the HTTP Post or HTTP Put message. Similarly, if throttling is activated on WFE 110 and WFE 110 receives a HTTP Get message request, WFE 110 rejects the HTTP Get message, typically by returning a busy error.

In addition to classifying messages by message type, the example classifier module 208 may also classify messages by message function. For example, when throttling is activated at example WFE 110, it may be desirable to throttle messages from a search engine crawler to prevent the search engine crawler from interrupting user triggered HTTP Post requests.

The example WFE 110 may include more than one classifier module. For example one classifier module may classify requests by HTTP function type. Another classifier module may classify requests by functionality. For example, WFE 110 may include a unique classifier module for Microsoft Sharepoint messages. If one classifier module designates a request message as a high priority and another classifier module designates a request message as a low priority, the request message is given a low priority. If only one classifier module matches the request message, the request message is given the priority associated with the classifier.

The example performance analysis module 210 permits the WFE to analyze the one or more performance monitors over time so that threshold levels for performance counters and other throttling parameters can be more accurately configured. For example, the performance analysis module 210 may determine that an excessive number of throttling states are being caused by the same performance counter exceeding a threshold. For this example, to minimize false alarms, the performance analysis module 210 may determine that the threshold limit for the performance counter should be increased. In other examples, the performance analysis module 210 may determine that the time interval between snapshots or the number of snapshots needed to activate throttling should be modified.

The example interface module 212 permits a system administrator to manually configure system parameters. For example, a system administrator may manually configure the system parameter thresholds for the one or more performance counters. The system administrator may manually configure the value of n, thereby configuring the number of time snapshots used to make a determination as to whether to activate throttling. The system administrator may also manually configure the time interval between snapshots. Other system parameters may also be configured.

The example interface module 212 typically provides a command line interface to permit the system administrator of configure the system parameters. In some embodiments, a graphical user interface may be used. Other user interfaces are possible.

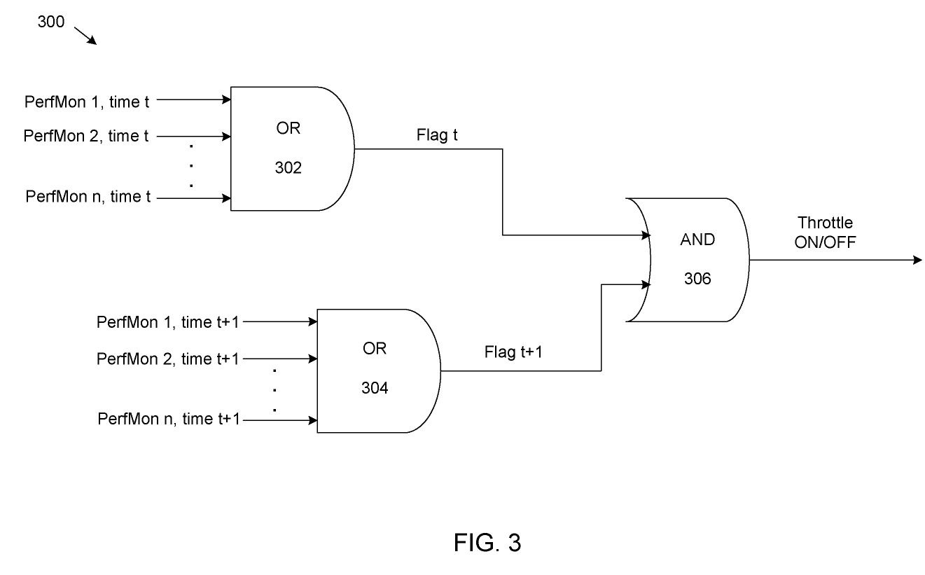

FIG. 3 shows example logic 300 used in the example throttling logic module 206. For the embodiment of the example throttling logic module 206 shown in FIG. 2, the value of n is equal to 2, indicating a two-step throttling mechanism. Thus, two OR gates and two throttling flags are shown. In other example embodiments, the number of OR gates and the number of throttling flags are equal to n. For example, a three-step throttling mechanism uses three OR gates, corresponding to three time snapshots. The OR gates are shown only as an example. In example embodiments, the logic used by the OR gates and the AND gate may be implemented by other means, for example in software.

Example OR gate 302 receives inputs from one or more performance monitors at time t. Time t constitutes time snapshot 1. At time t, if any of the one or more performance monitors determines that a monitored system parameter exceeds an upper limit or drops below a lower limit, example flag t is set. Example flag t is one input to example AND gate 306.

Example OR gate 304 receives inputs from the one or more performance monitors at time t+1. Time t+1 constitutes time snapshot 2. At time t+1, if any of the one or more performance monitors determines that a monitored system parameter exceeds an upper limit or drops below a lower limit, example flag t+1 is set. Example flag t+1 is a second input to example AND gate 306.

At time t+1, if flag t and flag t+1 are both set, AND gate 306 sets the example throttle on/off flag. When the example throttle on/off flag is set, throttling is activated at example WFE 110.

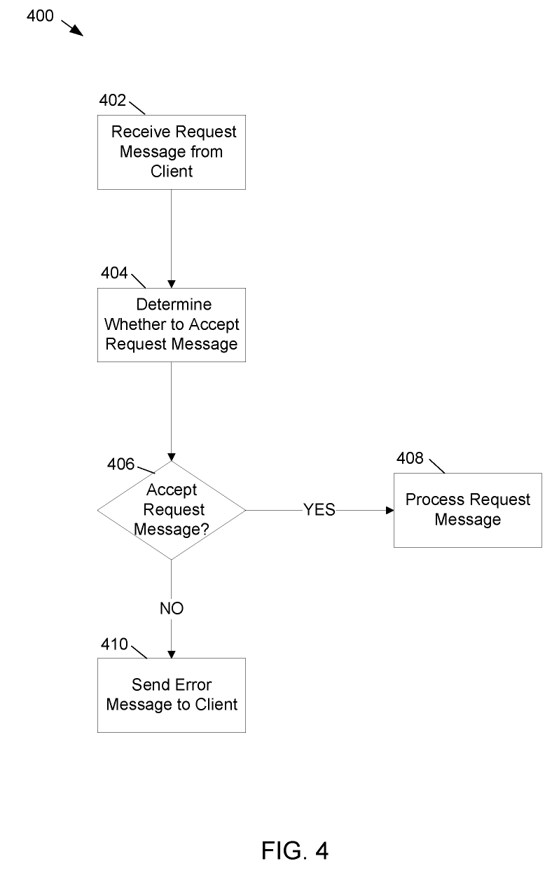

FIG. 4 is a flow chart illustrating an example operation 400 performed at example WFE 110. At operation 402, example WFE 110 receives a request message from example client 102. At operation 404, example WFE 110 determines whether to accept the request message for additional processing. When making the determination whether to accept the request message, example WFE 110 determines whether throttling is activated at WFE 110 and whether the request message of a type and functionality that be throttled. When example WFE 110 makes a determination to accept the request message at operation 406, the request message is processed at operation 408. When example WFE 110 makes a determination to reject the request message at operation 406, example WFE 110 sends a reply message to example client 102. The reply message is an error message, typically a busy message, indicating to example client 102 that the request message was rejected at example WFE 110.

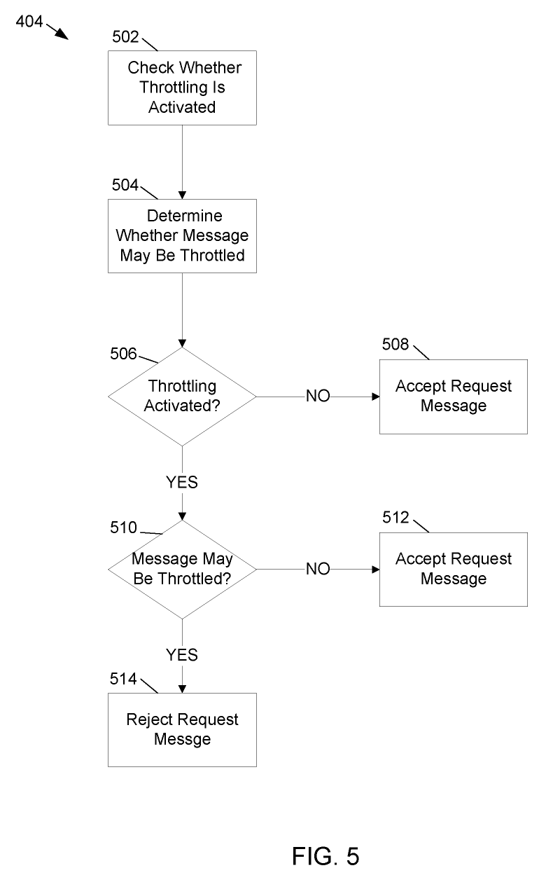

FIG. 5 is a flow chart illustrating in more detail example operation 404 performed at example WFE 110. In example operation 404, example WFE 110 determines whether to accept the request message from example client 102.

At operation 502, a check is made to determine whether throttling is activated on example WFE 110. At operation 504, a determination is made whether the example request message may be throttled. When a determination is made at operation 506 that throttling is not activated on example WFE 110, at operation 508, the request message is accepted at example WFE 110. When a determination is made at operation 506 that throttling is activated on example WFE 110 and when a determination is made at operation 510 that the request message may not be throttled, at operation 512, example WFE 110 accepts the example request message. An example request message that typically may not be throttled is a request message having an HTTP Post or HTTP Put message type.

When a determination is made at operation 506 that throttling is activated on example WFE 110 and when a determination is made at operation 510 that the request message may be throttled, at operation 514, WFE 110 rejects the example request message. An example request message that typically may be throttled is a request message having an HTTP Get message type.

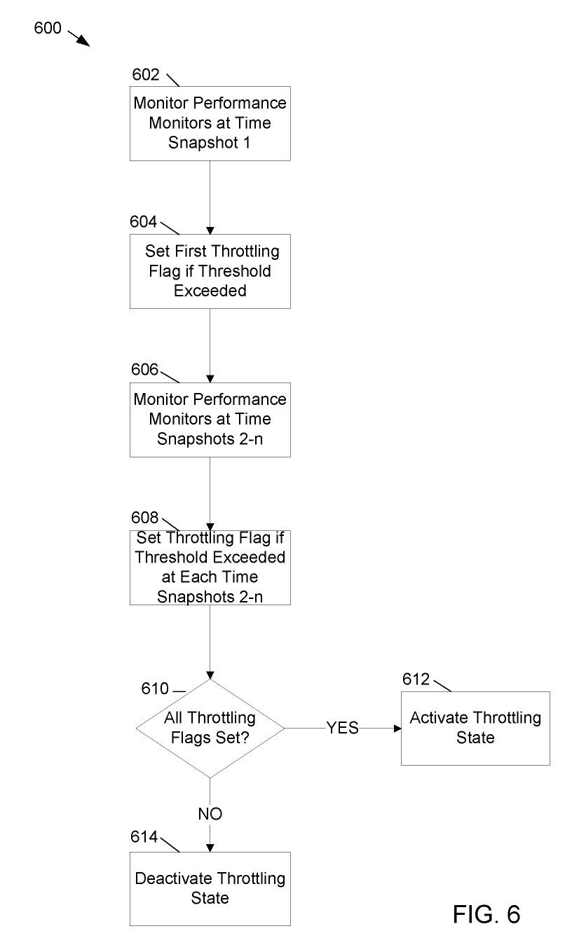

FIG. 6 is a flow chart illustrating in more detail example operation 600 performed at example WFE 110. In example operation 600, example WFE 110 determines whether throttling is activated at example WFE 110. The determination as to whether throttling is activated at example WFE 110 is made at regular time intervals. The determination as to whether throttling is activated at example WFE 110 is not made for each received request message for performance reasons.

At operation 602, example WFE 110 monitors the performance monitors on WFE 110 at time snapshot 1. If at least one system parameter monitored by the performance monitors at time snapshot 1 exceeds the predetermined threshold set for the system parameter, at operation 604 example WFE 110 sets a first throttling flag.

At operation 606, example WFE 110 monitors the performance monitors on WFE 110 at time snapshots 2-n, where time snapshots 2-n means time snapshot 2 through time snapshot n. If at least one system parameter monitored by the performance monitors at each of time snapshots 2-n exceeds the predetermined threshold set for the system parameter, at operation 608 example WFE 110 sets a throttling flag. A separate throttling flag is set for each time snapshot 2-n for which at least one system parameter monitored by the performance monitors at each time snapshot 2-n exceeds the predetermined threshold set for the system parameter. It should be understood that operations 606 and 608 are each multiple operations, one operation being performed at each of time snapshots 2-n.

If a determination is made at operation 610 that both throttling flags are set, at operation 612 WFE 110 activates throttling at WFE 110. If a determination is made at operation 610 that both throttling flags are not set, at operation 614 WFE 110 deactivates throttling at WFE 110 if throttling had been activated.

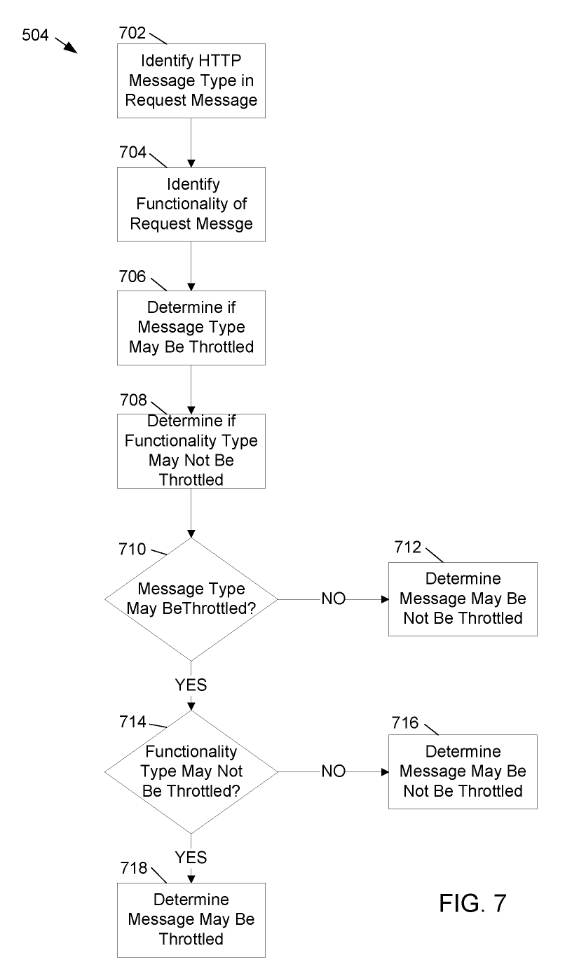

FIG. 7 is a flow chart illustrating in more detail example operation 504 performed at example WFE 110. In example operation 504, example WFE 110 determines whether the request message from example client 102 may be throttled at example WFE 110.

At operation 702, example WFE 110 identifies the HTTP message type in the request message from example client 102. Some examples of HTTP message types are HTTP Post, HTTP Put and HTTP Get. At operation 704, example WFE 110 identifies the functionality of the request message. For example the request message may be part of a crawler search request.

At operation 706, example WFE 110 determines whether a request message having the identified HTTP message type may be throttled. Typically HTTP message types of low priority, for example HTTP Get may be throttled and HTTP message types of high priority, for example HTTP Post and HTTP Put may not be throttled.

At operation 708, example WFE 110 determines whether a request message having the identified functionality may not be throttled. Messages having a functionality type indicating that the message is of high priority may not be throttled. In contrast, message having a functionality type that are not identified as having a high priority are typically throttled. For example a message type indicating a crawler functionality is typically throttled because crawler searches may be resource intensive and it is not desirable for these searches to interrupt request messages of high priority, for example HTTP Post or HTTP Put requests. Therefore, crawler searches are typically not allowed to complete without throttling.

At operation 710, if it is determined that the identified message type may not be throttled, at operation 712, a determination is made that the request message may not be throttled. At operation 710, if it is determined that the identified message type may be throttled and if at operation 714, it is determined that the functionality of the request message is such that the request message may not be throttled, at operation 716 a determination is made that the request message may not be throttled. At operation 710, if it is determined that the identified message type may be throttled and if at operation 714, it is determined that functionality of the request message does not prevent the request message from being throttled, at operation 718 a determination is made that the request message may be throttled.

In some example embodiments, the message type and the message functionality may be considered to be the same and may not be considered separately. In these example embodiments, operations 702 and 704 may be combined, operations 706 and 708 may be combined and operations 710-716 may be combined.

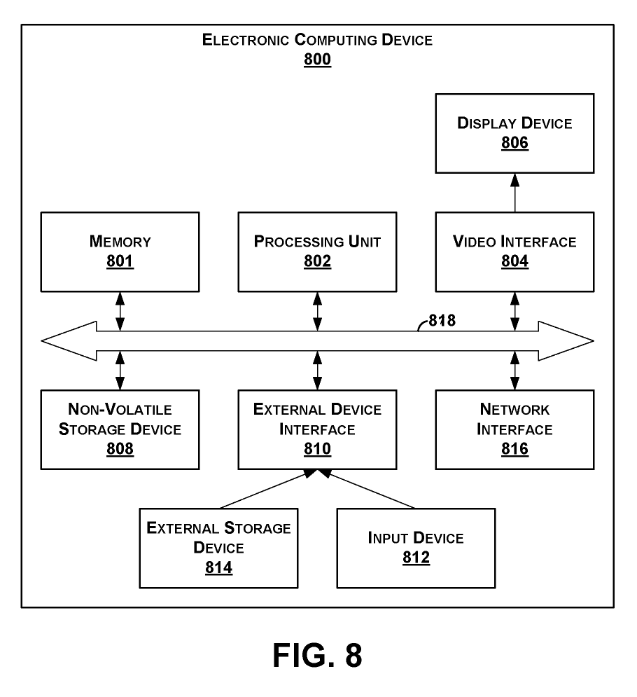

FIG. 8 is a block diagram illustrating example physical components on an electronic computing device 800. Client systems 102 and 104 and server systems 108, 110, 112, 114 and 116 and/or electronic computing devices within client systems 102 and 104 and/or server systems 108, 110, 112, 114 and 116 may be implemented in the manner of electronic computing device 800. As illustrated in the example of FIG. 8, electronic computing device 800 comprises a memory unit 801. Memory unit 801 is a computer-readable data storage medium that is capable of storing data and instructions. Memory unit 801 may be a variety of different types of computer-readable data storage media including, but not limited to, dynamic random access memory (DRAM), double data rate synchronous dynamic random access memory (DDR SDRAM), reduced latency DRAM, DDR SDRAM, DDR3 SDRAM, Rambus RAM, or other types of computer-readable data storage media.

In addition, electronic computing device 800 comprises a processing unit 802. In a first example, processing unit 802 may execute software instructions that cause processing unit 802 to provide specific functionality. In this first example, processing unit 802 may be implemented as one or more processing cores and/or as one or more separate microprocessors. For instance, in this first example, processing unit 802 may be implemented as one or more Intel Core2 microprocessors. Processing unit 802 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 802 may be implemented as an application specific integrated circuit (ASIC) that provides specific functionality. In a third example, processing unit 1002 may provide specific functionality by using an ASIC and by executing software instructions.

Electronic computing device 800 also comprises a video interface 804 that enables a clients system (102 and 104) or a server system (108, 110, 112, 114, 116 and 118) to output video information to display device 806. Display device 806 may be a variety of different types of display devices. For instance, display device 806 may be a cathode-ray tube display, an LCD display panel, a plasma screen display panel, a touch-sensitive display panel, a LED array, or another type of display device.

In addition, electronic device 802 includes a non-volatile storage device 808. Non-volatile storage device 808 is a computer-readable data storage medium that is capable of storage data and/or instructions. Non-volatile storage device 808 may be a variety of different types of different non-volatile storage devices. For example, non-volatile storage device 808 may be one or more hard disk drives, magnetic tape drives, CD-ROM drives, DVD-ROM drives, Blu-Ray disc drives, or other types on non-volatile storage devices.

Electronic computing device 800 also includes an external component interface 810 that enables client systems 102 and 104 and server systems 108, 110, 112, 114 and 116 to communicate with external components. As illustrated in the example of FIG. 8, external component interface 810 communicates with an input device 812 and an external storage device 814. In one implementation of electronic computing device 800, external component interface 810 is a Universal Serial Bus (USB) interface. In other implementations of electronic computing device 800, electronic computing device 800 may include another type of interface that enables electronic computing device 800 to communicate with input device and/or output devices. For instance, electronic computing device 800 may include a PS/2 interface. Input device 812 may be a variety of different types of devices including, but not limited to keyboards, mice, trackballs, stylus input devices, touch pads, touch-sensitive display devices, touch-sensitive display screens, or other types of input devices. External storage device 814 may be a variety of different types of computer-readable data storage media including magnetic tape, flash memory modules, magnetic disk drives, optical disc drives, and other computer-readable data storage media.

In addition, electronic computing device 800 includes a network interface 816 that enables electronic computing device 800 to send data to and receive data from network 106. Network interface 816 may be a variety of different types of network interface. For example, network interface 816 may be an Ethernet interface, a token-ring interface, a fiber optic interface, a wireless network interface (e.g. WiFi, WiMax, etc.), or another type of network interface.

Electronic computing device 800 also includes a communications medium 818 that facilitates communication among the various components of electronic computing device 800. Communications medium 818 may comprise one or more different types of communication media including, but not limited to, a PCI bus, a PCI Express bus, an accelerated graphics port (AGP) bus, an Infiniband interconnect, a serial Advanced Attachment (ATA) interconnect, a parallel ATA interconnect, a Fiber Channel interconnect, a USB bus, a Small Computer System Interface (SCSI) interface, or another type of communications medium.

Several computer-readable data storage media are illustrated in the example of FIG. 8 (i.e. memory unit 801, non-volatile storage device 808, and external storage device 814). Together, these computer-readable data storage media may constitute a single logical computer-readable data storage medium. This single logical computer-readable data storage medium may store instructions executable by processing unit 802. Actions described in the above description may result from the execution of the instructions stored on this single logical computer-readable data storage medium. Thus, when this description says that a particular logical module performs a particular action, such a statement may be interpreted to mean that instructions of the software module cause a processing unit, such as processing unit 802, to perform the action.

The various embodiments described above are provided by way of illustration only and should not be construed to limiting. Various modifications and changes that may be made to the embodiments described above without departing from the true spirit and scope of the disclosure.

What is claimed is:

1. A server computer, the server computer comprising:
a performance monitor module, the performance monitor module comprising one or more performance monitors, each of the one or more of the one or more performance monitors monitoring a system parameter of the server computer;
a throttling logic module, the throttling logic module determining if a system parameter monitored by a performance monitor exceeds a predetermined threshold, the throttling logic module setting a throttling flag when a system parameter exceeds a predetermined threshold; and
a throttling configuration module, the throttling configuration module storing the predetermined threshold for each system parameter monitored by the one or more performance monitors, the throttling configuration module also storing one or more throttling logic parameters;
wherein, the throttling logic module activates throttling at the server computer when at least one throttling flag is set for each of a predetermined number of time snapshots, the activation of throttling limiting the processing of request messages received by the server computer.

2. The server computer of claim 1, wherein limiting the processing of request messages received by the server computer comprises rejecting a request message.

3. The server computer of claim 1, wherein the predetermined number of time snapshots is configurable.

4. The server computer of claim 1, wherein the throttling logic module deactivates a throttling flag when the system parameter associated with the throttling flag falls below a predetermined threshold.

5. The server computer of claim 1, wherein the throttling logic module deactivates throttling when at least one throttling flag is not set for each of the predetermined number of time snapshots.

6. The server computer of claim 1, wherein the predetermined thresholds and the throttling logic parameters stored in the threshold configuration module are configurable.

7. The server computer of claim 1, further comprising a classifier module, the classifier module including one or more classifiers, each of the one or more classifiers identifying whether one or more classes of request messages may be throttled or may not be throttled.

8. The server computer of claim 7, wherein the classifier module identifies HTTP Get Messages as a type of request message that may be throttled.

9. The server computer of claim 7, wherein the classifier module identifies search messages as a type of request message that may be throttled.

10. The server computer of claim 1, further comprising a performance analysis module, the performance analysis module analyzing performance data at the server computer to determine the predetermined thresholds for the performance monitors.

11. The server computer of claim 1, further comprising an interface module, the interface module permitting the predetermined thresholds and the throttling logic parameters to be configured using an interface on the server computer.

12. A method for throttling messages at a server computer, the method comprising:
receiving a HTTP request message from a client computer at the server computer;
in response to receiving the HTTP request message at the server computer, determining whether to accept the request message at the server computer, wherein determining whether to accept the request message at the server computer comprises:
determining whether throttling is activated at the server computer;
determining whether the request message may be throttled;
when throttling is not activated at the server computer, accepting the request message at the server computer;
when throttling is activated at the server computer and the request message may not be throttled, accepting the request message at the server computer; and
when throttling is activated at the server computer and the request message may be throttled, rejecting the request message at the server computer; and
when a determination is made to reject the request message at the server computer, sending a reply message to the client computer, the reply message informing the client computer that the request message has been rejected at the server computer.

13. The method of claim 12, wherein determining whether throttling is activated on the server computer comprises:
at a time corresponding to a first time snapshot, monitoring the state of one or more performance monitors on the server computer;
in response to monitoring the state of the one or more performance monitors on the server computer at the time of the first time snapshot, when it is determined that a system parameter monitored by at least one of the one or more performance monitors exceeds a predetermined threshold, setting a first throttling flag;
determining a time corresponding to one or more additional time snapshots, each of the one or more additional time snapshots occurring at one or more predetermined time intervals from the first time snapshot;
at a time corresponding to each of the one or more additional time snapshots, monitoring the state of one or more performance monitors on the server computer;
in response to monitoring the state of one or more performance monitors on the server computer at the time of each of the one or more additional time snapshots, at each of the one or more additional time snapshots determining whether at least one of the one or more performance monitors determines that a system parameter monitored by at least one of the one or more performance monitors exceeds a predetermined threshold;
in response to monitoring the state of the one or more performance monitors on the server computer at the time of each of the one or more additional time snapshots, at each of the one or more additional time snapshots when it is determined that a system parameter monitored by at least one of the one or more performance monitors exceeds a predetermined threshold, setting an additional throttling flag;
when it is determined that a system parameter monitored by at least one of the one or more performance monitors exceeds a predetermined threshold at the time of the last time snapshot of the one or more additional time snapshots, determining whether the first throttling flag is set and whether a throttling flag is set for each of the one or more additional time snapshots; and
when it is determined that a system parameter monitored by at least one of the one or more performance monitors exceeds a predetermined threshold at the time of the last time snapshot of the one or more additional time snapshots and when it is determined that the first throttling flag is set and a throttling flag is set for each of the one or more additional time snapshots, activating throttling on the server computer.

14. The method of claim 12, wherein determining whether the request message may be throttled comprises:
identifying the HTTP message type of the request message;
identifying the functionality of the request message;
determining whether the identified HTTP message type of the request message is a HTTP message type that may be throttled;
determining whether the identified functionality of the request message is a functionality that may not be throttled;
when the identified HTTP message type of the request message is a HTTP message type that may not be throttled or when the identified functionality of the request message is a functionality that may not be throttled, determining that the request message may not be throttled; and
when the identified HTTP message type of the request message is a HTTP message type that may be throttled and when the identified functionality of the request message is a functionality that has not been identified as one that may not be throttled, determining that the request message may be throttled.

15. The method of claim 12, wherein determining whether the request message may be throttled further comprises using one or more classifiers to identify HTTP message types that are designated for throttling.

16. The method of claim 15, wherein the one or more classifiers identify HTTP Get Messages as a type of request message that may be throttled.

17. The method of claim 12, wherein the number of time snapshots is configurable.

18. The method of claim 12, wherein the predetermined threshold of each of the one or more performance monitors is configurable.

19. The method of claim 12, wherein the predetermined time interval between the first time snapshot and the second time snapshot is configurable.

20. A computer-readable data storage medium comprising instructions that, when executed by a processing unit of a server computer, cause the server computer to:
receive a HTTP request message from a client computer;
in response to receiving the HTTP request message, determine whether to accept the request message, wherein determine whether to accept the request message comprises:
at a time corresponding to a first time snapshot, monitor the state of one or more performance monitors on the server computer;
in response to monitoring the state of the one or more performance monitors on the server computer at the time of the first time snapshot, when it is determined that a system parameter monitored by at least one of the one or more performance monitors exceeds a predetermined threshold, set a first throttling flag;
determine a time corresponding to one or more additional time snapshots, each of the one or more additional time snapshots occurring at one or more predetermined time intervals from the first time snapshot;
at a time corresponding to each of the one or more additional time snapshots, monitor the state of one or more performance monitors on the server computer;
in response to monitoring the state of one or more performance monitors on the server computer at the time of each of the one or more additional time snapshots, at each of the one or more additional time snapshots determine whether at least one of the one or more performance monitors determines that a system parameter monitored by at least one of the one or more performance monitors exceeds a predetermined threshold;
in response to monitoring the state of the one or more performance monitors on the server computer at the time of each of the one or more additional time snapshots, at each of the one or more additional time snapshots when it is determined that a system parameter monitored by at least one of the one or more performance monitors exceeds a predetermined threshold, set an additional throttling flag;
when it is determined that a system parameter monitored by at least one of the one or more performance monitors exceeds a predetermined threshold at the time of the last time snapshot of the one or more additional time snapshots, determine whether the first throttling flag is set and whether a throttling flag is set for each of the one or more additional time snapshots;
when it is determined that a system parameter monitored by at least one of the one or more performance monitors exceeds a predetermined threshold at the time of the last time snapshot of the one or more additional time snapshots and when it is determined that the first throttling flag is set and a throttling flag is set for each of the one or more additional time snapshots, activate throttling on the server computer;
identify the HTTP message type of the request message;
identify the functionality of the request message;
determine whether the identified HTTP message type of the request message is a HTTP message type that may be throttled;
determine whether the identified functionality of the request message is a functionality that may not be throttled;
when the identified HTTP message type of the request message is a HTTP message type that may not be throttled or when the identified functionality of the request message is a functionality that may not be throttled, determine that the request message may not be throttled;
when the identified HTTP message type of the request message is a HTTP message type that may be throttled and when the identified functionality of the request message is a functionality that has not been identified as one that may not be throttled, determine that the request message may be throttled;
when throttling is not activated at the server computer, accept the request message at the server computer;
when throttling is activated at the server computer and the request message may not be throttled, accept the request message at the server computer; and
when throttling is activated at the server computer and the request message may be throttled, reject the request message at the server computer; and
when a determination is made to reject the request message at the server computer, send a reply message to the client computer, the reply message informing the client computer that the request message has been rejected at the server computer.
